(19) United States
(12) Patent Application Publication
(10) Pub. No.: US 2004/0011156 A1
(43) Pub. Date: Jan. 22, 2004

(54) High inertia - high mass steering wheel

(75) Inventors: Christopher D. Morgan, Sterling Heights, MI (US); Scott G. Warhover, Walled Lake, MI (US); Xiaoping Xu, Rochester Hills, MI (US)

Correspondence Address: KEY SAFETY SYSTEMS, INC., PATENT DEPARTMENT, 7000 NINETEEN MILE ROAD, STERLING HEIGHTS, MI, 48314, US

(73) Assignee: Breed Automotive Technology, Inc.

(21) Appl. No.: 10/458,354

(22) Filed: Jun. 10, 2003

Related U.S. Application Data
(60) Provisional application No. 60/396,462, filed on Jul. 16, 2002.

(51) Int. Cl. B62D 1/04

(52) U.S. Cl. 74/552

(57) ABSTRACT

A steering wheel comprising: a rim (24) and a hub member (22) and a plurality of spokes (26a-d) interconnecting the rim and hub member configured to have a first polar moment of inertia; the rim including a hollow space (43) and an insert (50) received within the hollow space, the rim and the insert configured to raise the effective polar moment of inertia of the steering wheel from the first polar moment to a level to reduce any shimmy of the steering wheel.

This application claims the benefit of U.S. Provisional Application No. 60/396,462, filed on Jul. 16, 2002. The disclosure of the above application is incorporated herein by reference.

### BACKGROUND AND SUMMARY OF THE INVENTION

The present invention relates to a steering wheel with a polar moment inertia sufficient to control steering wheel shimmy while also having a mass and stiffness that does not compromise driver safety nor dramatically reduce the principal vibration modes of the steering wheel to a level where they are again objectionable to the driver.

An inspection of a motorized vehicle will identify many disparate as well as related systems and components. The performance, as well as the performance specifications, of one of these systems or components often impacts or is interrelated with the performance specification and ultimately the performance of another system or component.

The vehicle suspension system typically includes springs, shock absorbers, rack and pinion mechanism and other linkages as well as the vehicle tires. Additionally, the suspension system is very much related to the vehicle's steering system, which comprises the tires, steering links, steering shaft, column and the steering wheel.

With the exception of being able to rotate, a basic steering wheel does not have movable parts. It is surprising how the design of such a “simple” component is an important element in the overall steering system. Putting aside safety-related factors, the relative importance of the steering wheel resides in the fact it is the direct connection between the driver's tactile senses and the vibrations and impulsive forces transmitted through the vehicle steering and suspension components. While someone may have said, “the critical element is where the tires meet the road” it will be seen for many issues the critical element is where the hands meet the steering wheel. For example, if the tires or wheels vibrate too much, this vibration will be a source of annoyance to the driver who senses these vibrations at the steering wheel. Unwarranted oscillatory vibration at the steering wheel is a primary cause for vehicle warranty claims, even though these issues originate at locations other than at the steering wheel.

A typical steering wheel will often be designed to have a low polar moment of inertia. As used herein, the polar moment of inertia is the inertia of the steering wheel about its central rotational axis. A low polar moment of inertia provides the driver the ability to quickly rotate the steering wheel from one position to another and makes the vehicle more responsive in an emergency avoidance situation. Additionally, the steering wheel generally must comport with driver safety standards as defined by motor vehicle safety standards FMVSS 203, FMVSS 208 and ECE 12.

Additionally, the physical characteristics of the steering wheel, that is, its inertia, mass, stiffness, etc., are initially defined or dictated in conjunction with the presumed performance specifications of the remainder of the steering system, as well as the suspension system. Occasionally, as the vehicle emerges from its production or pre-production design, the performance achieved by the steering system and suspension system do not comport with the original specifications and as a result of this, the vehicle may display an unwanted level of shimmy as well as other vibrational modes, which will inevitably become a source of annoyance to the driver as sensed by the vibration at the steering wheel. As used herein, “shimmy” refers to the impulsive or vibratory rotation or oscillation of the steering wheel about its rotational axis.

Additionally, the principal vibrational modes (other than shimmy), which are also felt at the steering wheel, may be reinforced by the less than optimum design of component parts of the steering and suspension systems. For the typical steering wheel, which is attached to a relatively thin metal steering column, the principal vibrational model is an oscillation, which causes the steering wheel to rotate or vibrate in a plane that pierces the twelve o'clock and six o'clock positions of the steering wheel. The next most significant vibrational mode causes the steering wheel to rotate or vibrate about a plane, which cuts through the three to nine o'clock positions of the steering wheel.

Once the vehicle (including tire) design is finalized, and subsequently after the various tools to make the component parts of the vehicle are completed (which often occurs at least eighteen months prior to the start of production), it becomes difficult in practice and an especially expensive task to change the achieved system performance by changing the design (and hence the performance) of a system or component of such a system. Consequently, if the suspension and/or steering system display a sub-par performance in actual vehicle testing there is a reluctance to modify these systems because of the huge expense in changing the tooling and related processes and necessary long lead time.

Surprisingly, many aspects of this sub-par rotational vibrational performance can be easily compensated for by changes to the steering wheel without unduly compromising steering wheel performance, driver safety or by making radically expensive changes to the tools.

It is a further object of the invention to provide a steering wheel whose mass, inertia, and vibration properties can be adjusted without requiring extensive retooling or adversely affecting occupant safety.

It is an object of the present invention to provide a steering wheel that has an improved resistance to induced vibration including shimmy without affecting occupant crash performance.

Accordingly the invention comprises: a steering wheel comprising: a rim and a hub member and a plurality of spokes interconnecting the rim and hub member, the components of the steering wheel are configured to initially have a first polar moment of inertia; wherein the rim includes a hollow space and wherein an insert received within the hollow space, the rim and the insert are configured to raise the effective polar moment of inertia of the steering wheel from the first polar moment to a level to reduce any shimmy of the steering wheel. In another embodiment of the invention a flexible insert is molded about the rim to increase the effective polar moment of inertia of the steering wheel.

Many other objects and purposes of the invention will be clear from the following detailed description of the drawings.

### BRIEF DESCRIPTION OF THE DRAWINGS

FIG. 1 is an isometric view of a prior art steering wheel.

FIG. 2 is a partial exploded view of the steering wheel of FIG. 1.

FIG. 3 diagrammatically shows an insert such as a preformed ring used to increase the polar moment of inertial of the steering wheel.

FIG. 3a shows an alternate embodiment of the invention.

FIG. 3b shows an enlarged view of a portion of FIG. 3a.

FIG. 4 is a cross-sectional view showing a portion of the armature (rim) and insert (of FIG. 3).

FIG. 4a is a cross-sectional view showing a portion of the armature (rim) and insert (of FIG. 3a).

FIG. 5 illustrates a cross-sectional view of a completed steering wheel.

FIG. 6 illustrates an alternate embodiment of the invention.

FIG. 7 illustrates another alternative embodiment of the invention.

FIG. 8 shows an alternate embodiment of the invention.

FIG. 9 shows graphs of amplitude of steering wheel vibration across a range of road speeds (also expressed as frequency).

### DETAILED DESCRIPTION OF THE DRAWINGS

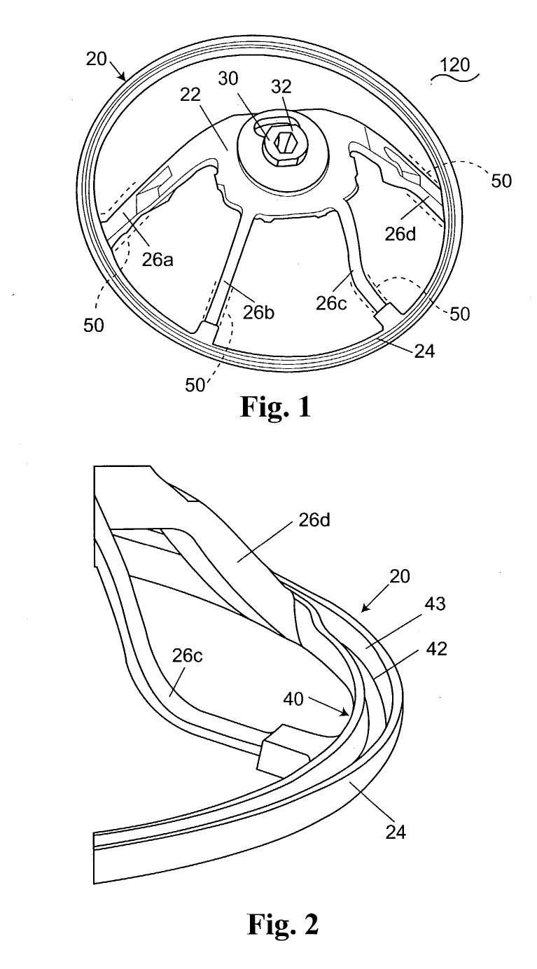

Reference is made to FIG. 1, which illustrates a steering wheel 120. While the illustrated steering wheel is of a four-spoke design, this is not a requirement of the present invention as two, three or more spokes can be used. The steering wheel comprises an armature 20 including hub plate 22, hub 30 and a rim 24 and a plurality of spokes such as 26a-26d, which connect the hub or hub plate to the rim.

The hub 30 extends from the underside of the hub plate 22, and hub 30 includes a central opening 32, which may be splined or threaded. One end of the steering shaft is received within the opening 32 of the hub.

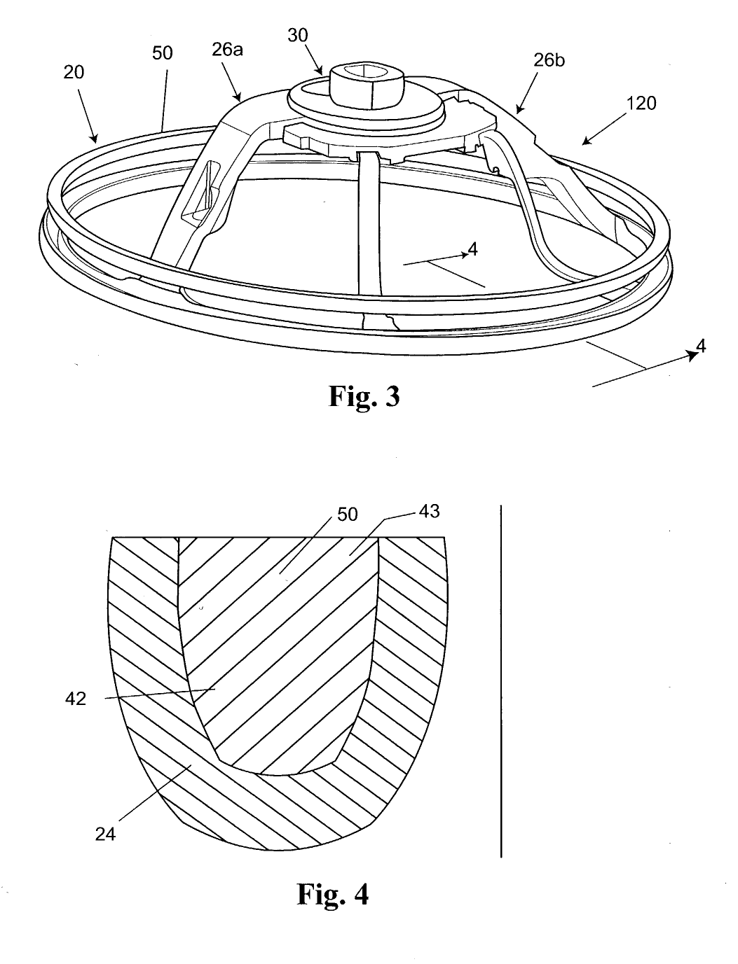

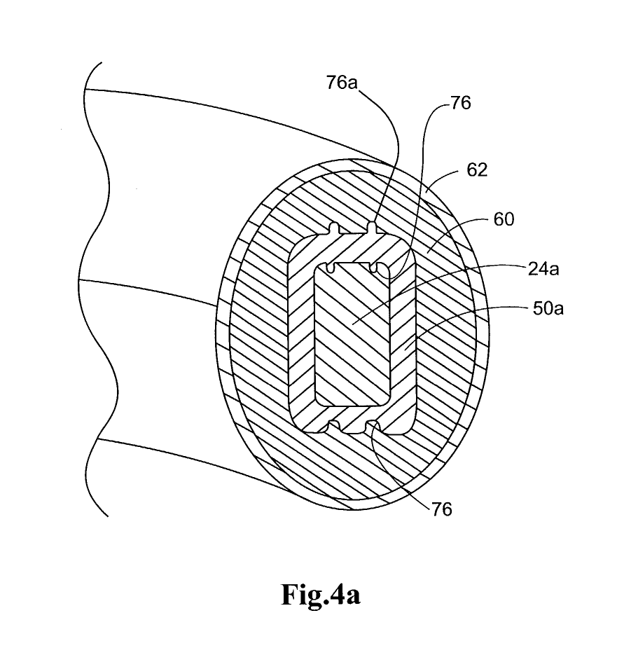

Reference is made to FIG. 2, which illustrates spokes 26c and d as well as a portion of the rim 24. As illustrated, the rim includes a double wall 40 that is closed on one side and is open on a side away from the occupant to provide a U-shaped channel 42, which extends generally about the entire periphery of the rim. The opening (open mouth or open slot) of the rim is shown by numeral 43 (also see FIG. 4).

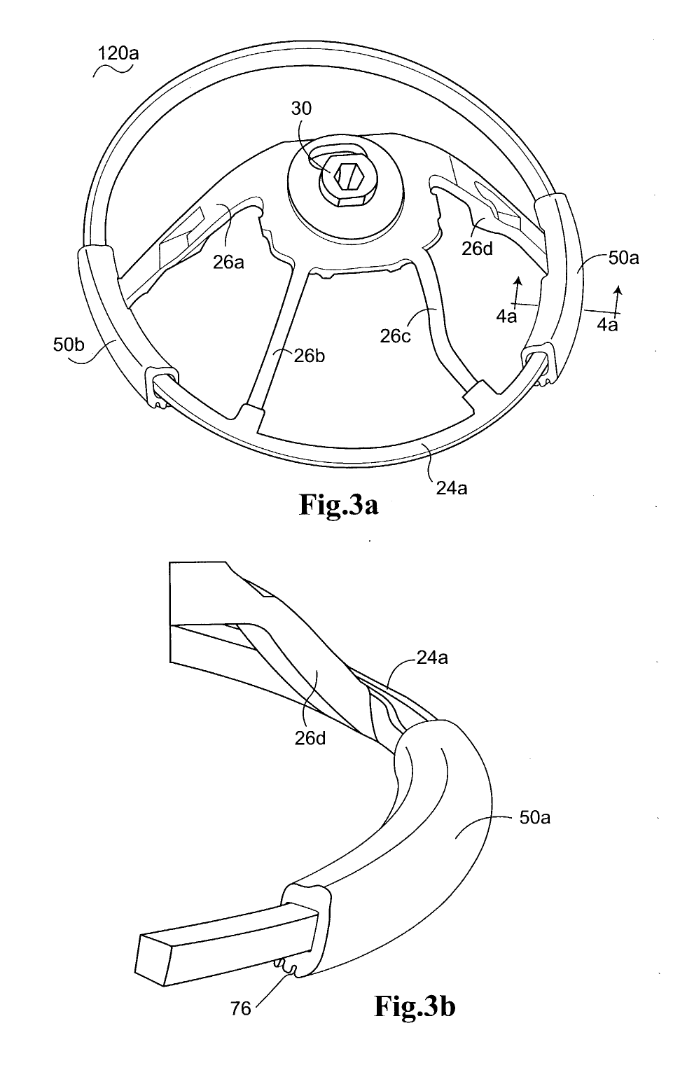

Reference is made to FIG. 3, which illustrates the steering wheel 120 and which diagrammatically shows, elevated from the steering wheel, an insert 50 in the form of a preformed ring. The ring or insert 50 is of dimension allowing it to fit within the opening (open mouth or slot) 43 of the rim 24. In practice the insert 50 is placed in the rim and a plastic casing 60 is molded (insert molded) thereabout. If the rim and the insert are compatible, the rim can be secured in place such as by gluing, crimping or tack welding prior to insert molding.

As can be appreciated, the introduction of the insert 50 at the outermost radius of the steering wheel 120 provides an effective means for increasing the polar moment of inertia by adding a minimum amount of mass. FIG. 4 shows a cross-sectional view of a U-shaped rim with the insert 50 placed therein.

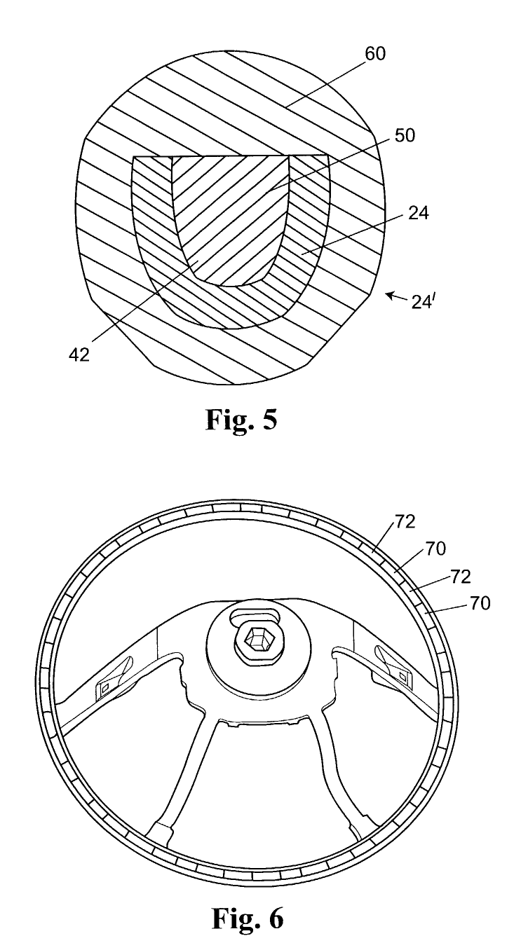

Reference is briefly made to FIG. 5, which illustrates a cross-sectional view of a completed steering wheel using the embodiment of FIGS. 2 and 3. The completed steering wheel 120 includes the armature 20 and the insert 50 with the plastic casing 60 molded thereabout. Typically, the casing is manufactured of foam, urethane or of PVC and placed about the rim, the spokes and a portion of the hub/hub plate. This casing 60 and the underlying rim 24 can be viewed as a completed outer rim 24′.

FIG. 3a shows another embodiment of the invention in which the rim 24a of the steering wheel 120a includes a generally rectangular cross-section. This rectangular cross-section can be solid (as shown), tubular, U-shaped or any other geometry. FIG. 3a shows two inserts 50a and 50b, which have been insert molded about two generally opposite portions of the rim 24a. FIG. 3b is an enlarged view showing one of the inserts 50b secured about the rim 24a of the steering wheel. FIG. 4a is a cross-sectional view of a complete steering wheel. In this embodiment a casing 60 is molded about the rim 24a and inserts 50a (and 50b). This casing may be constructed of plastic, polyurethane, or any other material common to steering wheel construction. An optional outer skin 62 or covering material may be provided by a sewn-on layer of leather or other material (such as synthetic leathers). One or more surfaces of the inserts 50a, 50b, the rim 24a, the plastic casing 60 or exterior outer skin or covering material (leather or polymer) may include one or more grooves 76 or projections 76a to provide added grabbing surfaces, which are helpful in securing the various parts together especially during a molding process.

It should be appreciated however, if it is not possible to achieve the needed increase in the polar moment of inertia by only adding the insert 50, the additional increase of the moment of inertia can be achieved by carefully choosing a material having a predetermined density to achieve the polar moment of inertia.

In the preferred embodiment of the invention the insert 50 can be a metal ring (insert) from a group of materials having high density, such as steel, lead, brass, copper, nickel, silver, tungsten, etc. Alternately, a polymer with a high density metallic filler material such as steel, lead, brass, copper, nickel, silver, tungsten, etc. can be substituted for the metal insert. For example, metallic, high-density polymers filled with tungsten (or other metals) are commonly available and can achieve densities equal to that of metallic lead. One such high-density polymer (a copper-polymer composite) is referred to as Ecomass® in the trade.

If the insert material used for the insert(s) 50 or 50a has a high Young's modulus the insert will increase the effective stiffness of the rim 24 (or 24a). Increased rim stiffness might not be compatible with crash safety and system requirements to which the rim was initially designed. The increase in rim stiffness while still permitting an increase in polar moment of inertia can be realized by employing insert materials having a low Young's modulus. Polymer materials typically have a much lower Young's modulus than metal materials while metals (steel and the like) have a high Young's modulus. Alternately, rim stiffness can be controlled by using geometry, such as alternating metal-polymer blocks as described, so that the bending stiffness of the assembled steering wheel is minimized.

Typical rim construction materials will have a Young's modulus in the range of 45 Gpa for Magnesium, 70 Gpa for aluminum, to 200 Gpa for steel. By comparison, the high density polymers used will be in the approximate range of 0.05 Gpa to 0.5 for polyurethanes up to 3-4 Gpa for nylon based compounds.

Reference is made to FIG. 6, which illustrates an alternate embodiment of the invention. In this embodiment the insert 50 is not formed in a continuous, homogenous ring but is made of a composite ring comprising alternative blocks of a high-density metal 70, such as steel or lead, linked by a softer polymer 72, such as Santoprene (TM), a thermoplastic elastomer, which could further be seeded with steel, lead, brass, copper, nickel, silver, tungsten, etc. for further increased density. As mentioned, the use of a segmented insert 50 reduces the stiffness of the composite rim (the rim 24 and insert) in comparison with using only a metal insert. In this embodiment the ring of alternating blocks is preformed prior to placement into the rim to facilitate assembly. Alternatively, the alternating blocks of material can be placed as individual parts into the rim 24.

As can be appreciated, during a typical accident the upper body of the occupant may impact the rim at all locations while a particular body part may also impact the rim but at a narrow region. Consequently, the stiffness of the rim must be chosen to sufficiently absorb the crash energy. If, however, the use of a metal to increase the polar moment of inertia also increases the overall rim stiffness, the use of the density-enhanced metal/polymer (tungsten/polymer) combination will not provide such a dramatic increase in stiffness, as it is relatively compliant.

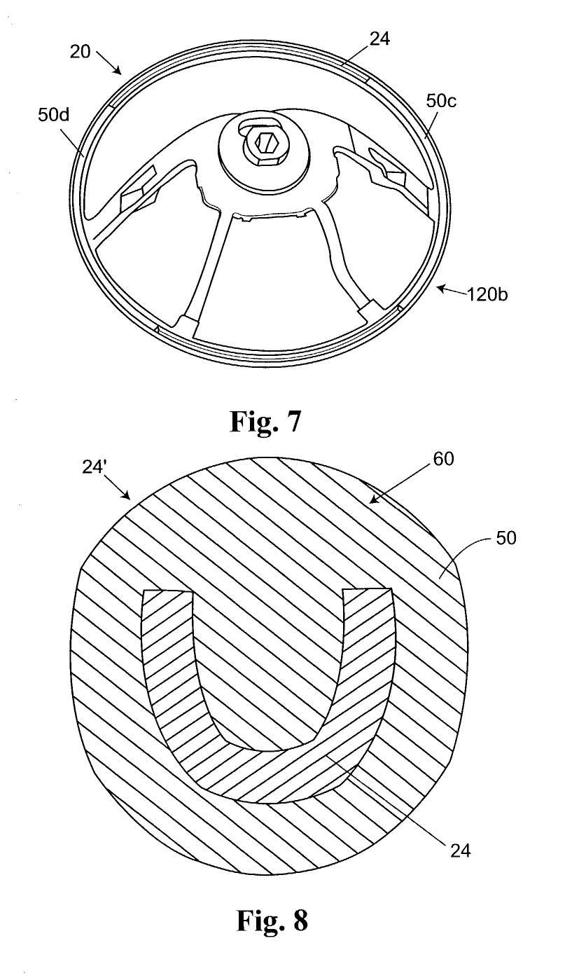

Reference is briefly made to FIG. 7, which shows an alternate steering wheel 120a in which a pair of inserts 50c and 50d is placed into the channel (slot, open mouth) 43 of the rim 24. As illustrated, insert 50c is located at the nominal three o'clock position of the steering wheel while 50d is located at the nominal nine o'clock position of the steering wheel. In this embodiment no insert material is located at the top or the bottom of the native steering, that is, in the respective twelve and six o'clock positions. Consequently, the mass and stiffness of the native steering wheel at these locations remain unchanged.

However, as can be appreciated one or more inserts 50, (50a, b, c, d or 72) can be placed at any position within the rim 24 of the steering wheel 20.

Reference is made to FIG. 8 in which the function of the insert 50 is combined into the casing material 60. For example the casing material is first chosen to provide a steering wheel 120 having the desired performance, which inherently assumes the other components (which affect shimmy and vibration) will conform to their respective standards. If however, these standards are not met, the polar moment of inertia can be changed to reduce shimmy by choosing the casing material to increase the polar moment of inertia appropriately. As can be seen from FIG. 8 the casing 60 now extends into the U-shaped channel of rim 24.

In practice for each of the enumerated embodiments of the invention, the first polar moment of inertia is initially chosen to provide satisfactory vibration and energy absorbing performance. The frequency response or sensed vibration at the steering wheel is subsequently measured and if objectionable, the resonance point of the steering wheel is changed by increasing the mass and polar moment of inertia of the steering wheel, yielding a scenario in which the sensed vibration at the steering wheel is reduced.

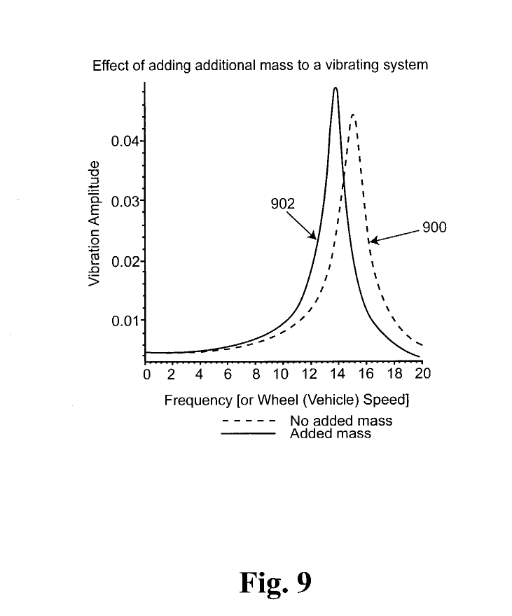

In general most steering systems will show an induced resonance in the range of about 10-20 Hz. Consequently, the polar moment of inertia for the nominally designed steering wheel is chosen to move the system resonance away from this resonance point based on an assumption the other steering and suspension components have been or will be designed to an agreed-upon performance specification. Reference is made to FIG. 9, which is a first graph 900, which shows the amplitude, in displacement, of steering wheel vibration (the steering wheel is characterized as having a first polar moment of inertia) across a range of road speeds. Graph 902 shows steering wheel vibration (for a steering wheel with an increased polar moment of inertia) across the same range of road speeds.

Several conclusions can be made from FIG. 9. At and above the speed of interest (where the initially designed and unmodified steering wheel vibrates the most, due in part to the non-conformity of other components of the system), which in this example is between 14 and 16 Hz, the addition of polar moment of inertia will lower the system resonance point (resonance frequency) to significantly reduce the vibration amplitude sensed at the steering wheel in the above range of frequencies. At speeds well above or below a transition speed, that is, where graph 900 intersects graph 902, the addition of mass has zero effect on the vibration amplitude.

If the steering wheel vibrates when the vehicle operates at for example, a commonly driven speed of about 65 or 70 MPH (which may result in an induced steering wheel resonance at about 15 Hz for example), then the addition of mass (or inertia) will move the vibration from this resonance frequency to a resonance frequency which corresponds to a less commonly achieved vehicle speed (one which occurs less during normal road driving) making the driving experience more comfortable as the steering wheel, with a modified design (with a new polar moment of inertia), compensates for the less than optimum system response of other steering and suspension components. The new or modified level of polar moment of inertia will reduce shimmy at frequencies at and above the resonance frequency of the “original” level of polar moment of inertia. Furthermore, the new level of polar moment of inertia will reduce shimmy at frequencies somewhat below this frequency.

Reference is again made to FIG. 1, which shows a further embodiment of the invention. In this embodiment, the insert 50 is secured about one or more spokes 26a-d. More particularly, the insert is located at a radially remote portion of the spoke. The insert 50 can be insert molded, or physically secured at these locations.

Many changes and modifications in the above-described embodiment of the invention can, of course, be carried out without departing from the scope thereof. Accordingly, that scope is intended to be limited only by the scope of the appended claims.

1. A steering wheel comprising:
a rim (24) and a hub member (22) and a plurality of spokes (26a-d) interconnecting the rim and hub member, and configured to have a first polar moment of inertia, the rim, hub member and plurality of spokes also exhibiting a predetermined energy absorbing characteristic;
an insert (50, 50a, 72) secured to one of the spokes and the rim configured to raise the effective polar moment of inertia of the steering wheel from the first level of first moment of inertia to a second level to reduce shimmy of the steering wheel.

2. The steering wheel as defined in claim 1 wherein the rim is formed using a material having a high Young's modulus and the insert is formed using a material having a relatively low Young's modulus.

3. The steering wheel as defined in claim 2 wherein the Young's modulus of the rim material is in the range of 45 Gpa to 200 Gpa.

4. The steering wheel as defined in claim 3 wherein the rim is made from a material in the group of aluminum, magnesium and steel.

5. The steering wheel as defined in claim 4 wherein the insert is made from a material comprising a high-density metallic polymer compound copper-elastomer mixture.

6. The steering wheel as defined in claim 1 wherein the insert is molded about at least two opposing sections of the rim.

7. The steering wheel as defined in claim 6 wherein the rim comprises molded magnesium or aluminum.

8. The steering wheel as defined in claim 2 wherein the insert material has a Young's modulus in the range of 0.05 Gpa to 0.5 Gpa.

9. A steering wheel comprising:
a rim (24) and a hub member (22) and a plurality of spokes (26a-d) interconnecting the rim and hub member, and configured to have a first polar moment of inertia;
the rim including a hollow space (43) and an insert (50) received within the hollow space, the rim and the insert configured to raise the effective polar moment of inertia of the steering wheel from the first polar moment to a level to reduce any shimmy of the steering wheel.

10. The device as defined in claim 9 wherein the hollow space (43) extends 360° about the rim.

11. The device as defined in claim 10 wherein the insert (50) includes a plurality of segmented parts (50a, 50b).

12. The device as defined in claim 9 wherein the rim comprises one of a homogenous material and a composite material.

13. The device as defined in claim 11 wherein the insert is metal.

14. The device as defined in claim 11 wherein the insert is a composite material comprising adjacent blocks of metal and a polymer.

15. The insert as defined in claim 11 wherein the insert comprises a homogenous mixture of a metal and a high-density polymer.

16. A method of monitoring steering wheel shimmy and for correcting to an acceptable level, the method including the steps of:
providing a steering wheel characterized as having a first polar moment of inertia;
monitoring steering wheel shimmy in conjunction with the use of the steering wheel;
adding an insert to or about the rim of an armature of the steering wheel to increase the polar moment of inertia of the steering wheel to a level to reduce the measured level of shimmy.
